(19) United States
(12) Patent Application Publication
(10) Pub. No.: US 2016/0199888 A1
(43) Pub. Date: Jul. 14, 2016

(54) DEPOSIT BUILD-UP MONITORING, IDENTIFICATION AND REMOVAL OPTIMIZATION FOR CONDUITS

(71) Applicant: HALLIBURTON ENERGY SERVICES, INC., Houston, TX (US)

(72) Inventor: Mikko Jaaskelainen, Katy, TX (US)

(21) Appl. No.: 14/913,232

(22) PCT Filed: Dec. 4, 2013
(86) PCT No.: PCT/US2013/073167

§ 371 Date: Feb. 19, 2016

(51) Int. Cl. B08B 9/032; G01H 9/00

(52) U.S. Cl. CPC B08B 9/032; G01H 9/002; G01H 9/004

(57) ABSTRACT

A method of mitigating deposit build-up in a conduit can include an optical distributed acoustic sensing system detecting a substance as the substance flows through the conduit, and determining a location and volume of the deposit build-up along the conduit, based on the detecting. A conduit monitoring system can include a chemical treatment supply and an optical distributed acoustic sensing system, the chemical treatment supply automatically delivering a chemical treatment into a conduit in response to detection by the optical distributed acoustic sensing system of a deposit build-up in the conduit. Another method of mitigating deposit build-up can include an optical distributed acoustic sensing system detecting a substance as it flows through a conduit, determining a location and volume of the deposit build-up along the conduit, based on the detecting, and automatically controlling a chemical treatment supply, based on the determining, thereby optimizing mitigation of the deposit build-up.

### TECHNICAL FIELD

This disclosure relates generally to equipment utilized and operations performed in conjunction with flowing fluid through conduits and, in one example described below, more particularly provides for deposit build-up monitoring, identification and removal optimization for conduits.

### BACKGROUND

Build-up of deposits in a conduit (such as, a pipeline or a tubular string in a well, etc.) can have a number of undesired effects. For example, increased energy may be required to pump fluid through the conduit at a given flow rate, expenses may be incurred to remove the deposits, efficiency of fluid delivery via the conduit may be impaired, a useful life of the conduit may be shortened, etc. Therefore, it will be appreciated that improvements are continually needed in the arts of monitoring, preventing and mitigating the build-up of deposits in conduits.

### BRIEF DESCRIPTION OF THE DRAWINGS

FIGS. 1A & B are representative cross-sectional views of conduits which can benefit from use of principles of this disclosure.

FIG. 2 is a representative partially cross-sectional view of a system that can embody the principles of this disclosure.

FIGS. 3A-D are representative graphs of distance versus time, velocity versus distance, flow area versus distance and deposit thickness versus distance for an example determination of deposit thickness and location along a conduit.

FIG. 4 is a representative flowchart for a method that can embody the principles of this disclosure.

### DETAILED DESCRIPTION

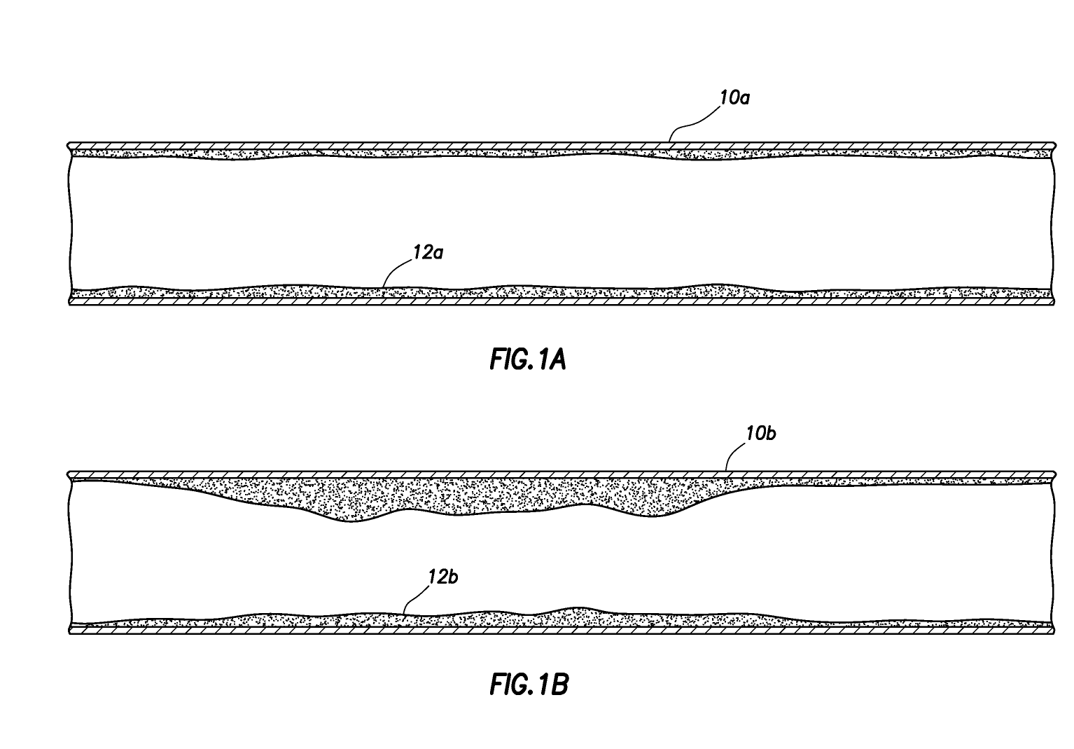

Representatively illustrated in FIGS. 1A&B are example conduits 10a,b which can benefit from the principles of this disclosure. However, it should be clearly understood that the conduits 10a,b are merely examples of an application of the principles of this disclosure in practice, and a wide variety of other examples are possible. Therefore, the scope of this disclosure is not limited at all to the details of the conduits 10a,b described herein and/or depicted in the drawings.

In FIG. 1A, a deposit build-up 12a is relatively uniformly distributed along an interior of the conduit 10a, although the deposit build-up may be somewhat thicker on a lower side of the conduit interior, as compared to an upper side of the conduit interior. In contrast, a deposit build-up 12b in the conduit 10b of FIG. 1B varies substantially along the length of the conduit. The deposit build-ups 12a,b could be any types of deposit build-ups (for example, paraffin, scaling, hydrates, sand or well fines, etc.).

It will be appreciated by those skilled in the art that prior methods of determining a deposit build-up by measuring an overall time of flight of an object (such as, a pig, a gel pill, a tracer, etc.) to traverse through a conduit can only determine an average of the deposit build-up in the conduit. Such methods cannot determine specific thicknesses of the deposit build-up at specific locations.

For example, the time of flight of an object flowed through the conduit 10a of FIG. 1A might be the same as, or different from, the time of flight of the same object flowed through the conduit 10b of FIG. 1B, at a given flow rate. If the times of flight are the same, one might assume that the deposit build-ups 12a,b are also the same, but this assumption would clearly be incorrect. If the times of flight are different, then the difference still gives no indication of the characteristics of the deposit build-ups 12a,b that cause the times of flight to be different.

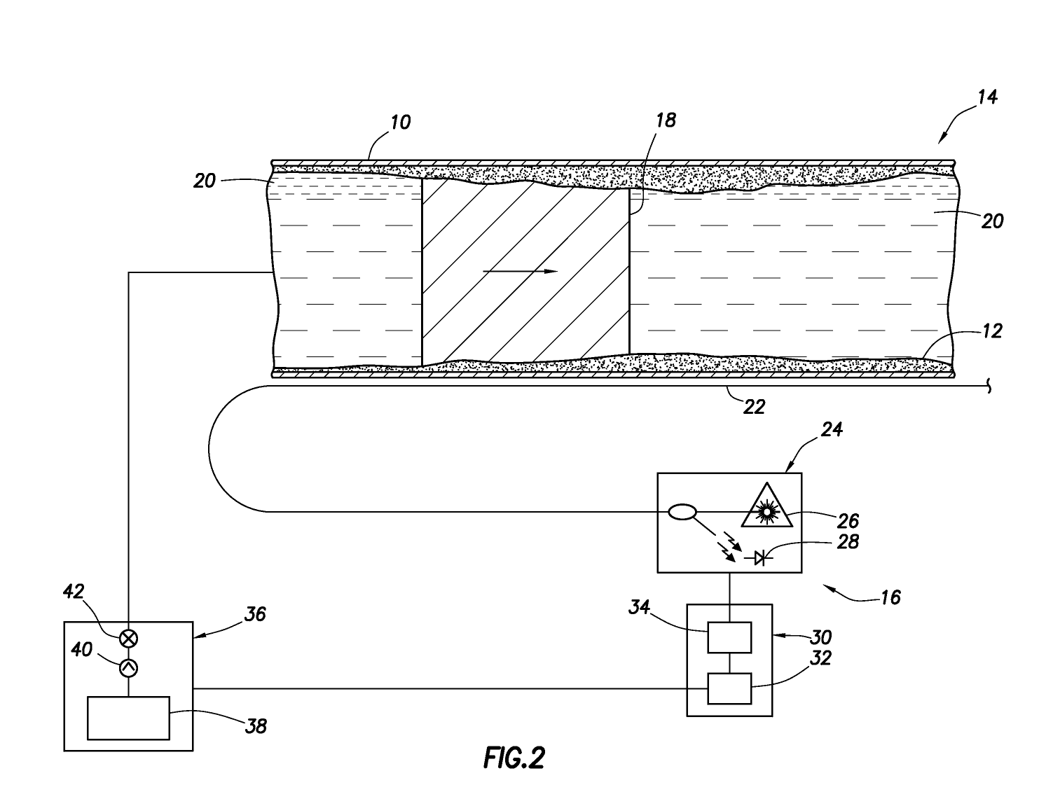

Representatively illustrated in FIG. 2 is a monitoring system 14 for use with a conduit 10, which system can embody principles of this disclosure. However, it should be clearly understood that the system 14 (and an associated method) are merely one example of an application of the principles of this disclosure in practice, and a wide variety of other examples are possible. Therefore, the scope of this disclosure is not limited at all to the details of the system 14 and method described herein and/or depicted in the drawings.

In the system 14 of FIG. 2, an optical distributed acoustic sensing system 16 is used to track displacement of a substance 18 as it flows through the conduit 10. The substance 18 may, for example, comprise a gel pill or a chemical treatment for mitigating the deposit build-up 12. In examples described below, the substance 18 has an acoustic property (such as, acoustic velocity or density) different from that of ambient fluid 20 in the conduit 10.

The optical distributed acoustic sensing (DAS) system 16 includes an optical waveguide 22 (such as, an optical fiber, an optical ribbon, etc.) that extends along the conduit 10. The optical waveguide 22 may comprise a single mode or multi-mode waveguide, or any combination thereof.

In some examples, multiple optical waveguides 22 may be distributed about the conduit 10. In other examples, the optical waveguide 22 could be wrapped about the conduit 10, positioned in a zig-zag pattern about the conduit, etc.

The optical waveguide 22 could be adjacent to, or spaced apart from, the conduit 10. The optical waveguide 22 may be contained in a tube, an armored cable or another protective covering. Thus, the scope of this disclosure is not limited to any particular details (such as, number, position, construction, etc.) of the optical waveguide 22.

The optical waveguide 22 is connected to an optical interrogator 24 (for example, at a monitoring station). In this example, the interrogator 24 includes at least an optical source 26 (such as, an infrared laser, a light emitting diode, etc.) and an optical sensor 28 (such as, a photo-detector, photodiode, etc.). In some examples, the interrogator 24 could include an optical time domain reflectometer (OTDR) and/or other optical and signal processing equipment.

The interrogator 24 may detect Brillouin backscatter gain, coherent Rayleigh backscatter, and/or Raman backscatter which results from light being transmitted through the optical waveguide 22. In other examples, separate interrogators 24 may be used to detect different types of optical scattering. However, the scope of this disclosure is not limited to use of any particular type or number of interrogators 24.

Operation of the interrogator 24 is controlled by a computer 30 including, for example, at least a processor 32 and memory 34. Instructions for operating the interrogator 24, and information output by the interrogator, may be stored in the memory 34. The computer 30 also preferably includes provisions for user input and output (such as, a keyboard, display, printer, touch-sensitive input, etc.). However, the scope of this disclosure is not limited to use of any particular type of computer.

In this example, the optical waveguide 22 is used to detect acoustic or vibrational energy as distributed along the waveguide. In other examples, the optical waveguide 22 could also be used to detect temperature and/or other parameters as distributed along the waveguide 22. In some examples, different optical waveguides 22 may be used to detect respective different parameters.

One or more distributed optical sensing techniques may be used in the system 10. These techniques can include detection of Brillouin scattering and/or coherent Rayleigh scattering resulting from transmission of light through the optical waveguide 22. Raman scattering may be detected and, if used in conjunction with detection of Brillouin scattering, may be used for thermally calibrating the Brillouin scatter detection data in situations, for example, where accurate strain measurements are desired.

Optical sensing techniques can be used to detect static strain, dynamic strain, acoustic vibration and/or temperature. These optical sensing techniques may be combined with any other optical sensing techniques, such as hydrogen sensing, stress sensing, etc.

Stimulated Brillouin scatter detection can be used to monitor strain and/or temperature along the optical waveguide 22. Coherent Rayleigh scatter can be detected as an indication of vibration of the optical waveguide 22, or as an indication of acoustic energy reaching the optical waveguide.

The optical waveguide 22 could include one or more waveguides for Brillouin scatter detection, depending on the Brillouin method used (e.g., linear spontaneous or non-linear stimulated). The Brillouin scattering detection technique measures the temperature and/or strain via corresponding scattered photon frequency shift in the waveguide 22 at a given location along the waveguide.

Coherent Rayleigh scatter detection can be used to monitor dynamic strain (e.g., acoustic pressure and vibration). Coherent Rayleigh scatter detection techniques can detect acoustic signals which result in vibration of the optical waveguide 22.

Raman scatter detection techniques are preferably used for monitoring distributed temperature. Such techniques are known to those skilled in the art as distributed temperature sensing (DTS).

Raman scatter is relatively insensitive to distributed strain, although localized bending in a waveguide can be detected. Temperature measurements obtained using Raman scatter detection techniques can, for example, be used for temperature calibration of Brillouin scatter measurements.

Raman light scattering is caused by thermally influenced molecular vibrations. Consequently, the scattered light carries the local temperature information at the point where the scattering occurred.

The amplitude of an Anti-Stokes component is strongly temperature dependent, whereas the amplitude of a Stokes component of the backscattered light is not. Raman scatter sensing requires some optical-domain filtering to isolate the relevant optical frequency (or optical wavelength) components, and is based on the recording and computation of the ratio between Anti-Stokes and Stokes amplitude, which contains the temperature information.

Since the magnitude of the spontaneous Raman scattered light is quite low (e.g., 10 dB less than Brillouin scattering), high numerical aperture (high NA) multi-mode optical waveguides are typically used, in order to maximize the guided intensity of the backscattered light. However, the relatively high attenuation characteristics of highly doped, high NA, graded index multi-mode waveguides, in particular, limit the range of Raman-based systems to approximately 10 km.

Brillouin light scattering occurs as a result of interaction between a propagating optical signal and thermally excited acoustic waves (e.g., within the GHz range) present in silica optical material. This gives rise to frequency shifted components in the optical domain, and can be seen as the diffraction of light on a dynamic in situ “virtual” optical grating generated by an acoustic wave within the optical media. Note that an acoustic wave is actually a pressure wave which introduces a modulation of the index of refraction via an elasto-optic effect.

The diffracted light experiences a Doppler shift, since the grating propagates at the acoustic velocity in the optical media. The acoustic velocity is directly related to the silica media density, which is temperature and strain dependent. As a result, the so-called Brillouin frequency shift carries with it information about the local temperature and strain of the optical media.

Note that Raman and Brillouin scattering effects are associated with different dynamic non-homogeneities in silica optical media and, therefore, have completely different spectral characteristics.

Coherent Rayleigh light scattering is also caused by fluctuations or non-homogeneities in silica optical media density, but this form of scattering is purely “elastic.” In contrast, both Raman and Brillouin scattering effects are “inelastic,” in that “new” light or photons are generated from the propagation of light through the media.

In the case of coherent Rayleigh light scattering, temperature or strain changes are identical to an optical source (e.g., very coherent laser) wavelength change. Unlike conventional Rayleigh scatter detection techniques (using common optical time domain reflectometers), because of the extremely narrow spectral width of the optical source (with associated long coherence length and time), coherent Rayleigh (or phase Rayleigh) scatter signals experience optical phase sensitivity resulting from coherent addition of amplitudes of the light scattered from different parts of the optical media which arrive simultaneously at a photo-detector.

The optical DAS system 16 is capable of tracking the substance 18 as it flows through the conduit 10. Due to the substance's 18 different acoustic property (or properties) as compared to that of the ambient fluid 20, acoustic “noise” generated by flow of the substance and the ambient fluid through the conduit 10 will be detected differently at different locations along the optical waveguide 22. That is, at any particular location, the acoustic “noise” detected by the optical waveguide 22 will change when the substance 18 flows past that location.

In the FIG. 2 example, the optical DAS system 16 can be connected to a chemical treatment supply 36. The chemical treatment supply 36 can include a chemical treatment reservoir 38, as well as a pump 40, valve 42 and/or other flow control devices, sensors, etc., for delivering the chemical treatment into the conduit 10.

As described more fully below, locations and thicknesses of the deposit build-up 12 can be accurately determined using the system 14, and this information can be used to optimize delivery of a chemical treatment into the conduit 10, so that mitigation of the deposit build-up can be optimized. This process can be implemented automatically, so that the mitigation is carried out without human intervention (or with only minimal human intervention, for example, to initiate the process, to respond to any alarms, etc.).

If the substance 18 tracked along the conduit 10 comprises the chemical treatment, the chemical treatment supply 36 may be a source of that chemical treatment. Thus, the computer 30 of the optical DAS system 16 can be used to cause the chemical treatment supply 36 to deliver the chemical treatment into the conduit 10.

Alternatively, the chemical treatment supply 36 may include a computer to control its operation in response to input from the optical DAS system 16. For example, the input from the optical DAS system 16 may include information regarding the tracking of the substance 18 along the conduit 10. The chemical treatment supply 36 computer can use this information to determine the locations and thicknesses of the deposit build-up 12 along the conduit 10, and thereby determine appropriate parameters (such as, frequency, location, duration, concentration, volume, quantity, etc.) for the chemical treatment, in order to optimize the mitigation of the deposit build-up.

Thus, these functions may be performed by the computer 30 of the optical DAS system 16, by a computer of the chemical treatment supply 36, or by another computer. The scope of this disclosure is not limited to any particular position of a computer that determines locations and thicknesses of the deposit build-up 12, or that determines appropriate parameters for the chemical treatment, or that controls operation of the chemical treatment supply 36.

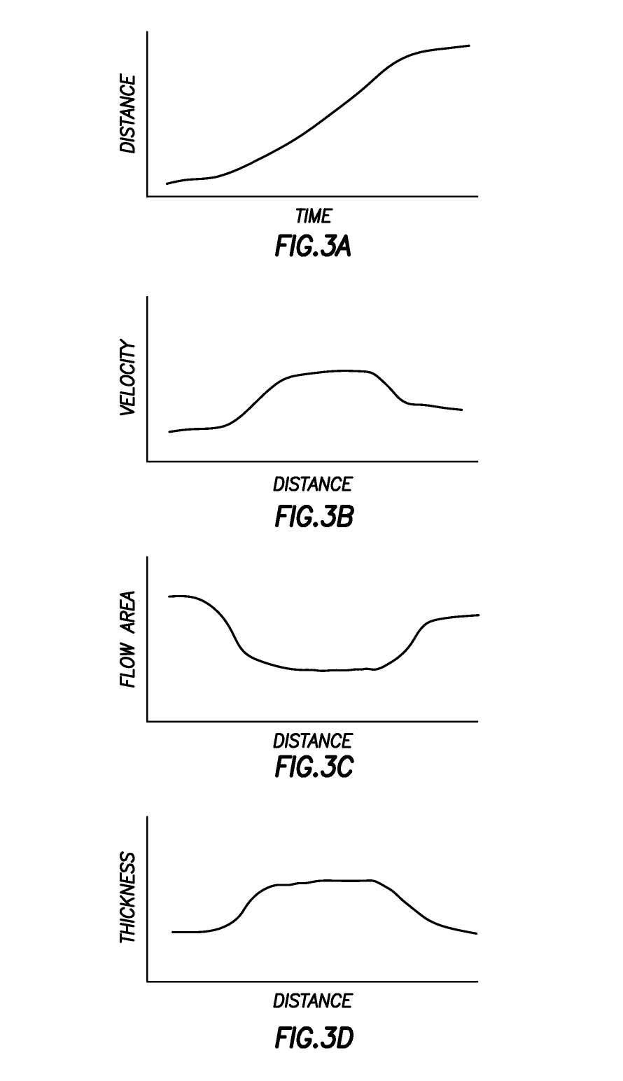

Referring additionally now to FIGS. 3A-D, representative graphs are depicted for an example determination of deposit build-up 12 locations and thicknesses along the conduit 10 in the system 14. The determination of deposit build-up 12 locations and thicknesses in this example is based on the tracking of the substance 18 by the optical DAS system 16 as the substance flows through the conduit 10 at a substantially constant flow rate.

In FIG. 3A, a graph of distance along the conduit 10 versus time is representatively illustrated. This graph depicts the displacement of the substance 18 along the conduit 10, as detected by the optical DAS system 16.

In FIG. 3B, a graph of velocity of the substance 18 versus distance along the conduit 10 is representatively illustrated. Note that the velocity of the substance 18 is a slope (derivative) of the FIG. 3A distance versus time curve.

In FIG. 3C, a graph of flow area of the conduit 10 versus distance along the conduit is representatively illustrated. At any given distance along the conduit 10, if the velocity is known (from FIG. 3B) and the flow rate is known, the flow area can be readily calculated (flow area=flow rate/velocity). A flow diameter can be calculated from the flow area (flow diameter=(4*flow area/π)^{1/2}).

In FIG. 3D, a graph of deposit build-up 12 thickness versus distance along the conduit 10 is representatively illustrated. Since an unobstructed inner diameter of the conduit 10 is known, the average thickness of the deposit build-up 12 at a particular location along the conduit can be readily calculated (thickness=(unobstructed inner diameter−flow diameter)/2). Thus, the thickness of the deposit build-up 12 at any location along the conduit 10 can be determined using the system 14.

Another deposit build-up 12 parameter of interest for controlling chemical treatment is a volume of the deposit build-up. The deposit build-up 12 volume can be determined by integrating the FIG. 3D thickness versus distance curve.

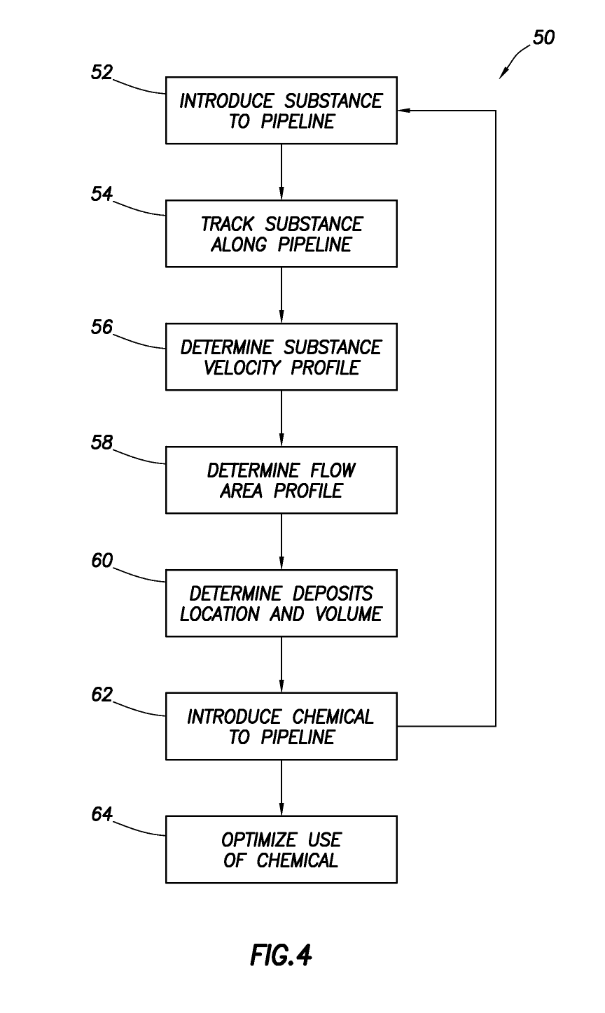

Referring additionally now to FIG. 4, a flowchart for a method 50 of mitigating the deposit build-up 12 in the conduit 10 is representatively illustrated. The method 50 may be performed using the system 14 of FIG. 2, or it may be performed using other systems, conduits, etc.

In step 52, the substance 18 is introduced into the conduit 10 (in this example, a pipeline). The substance 18 may be a chemical treatment delivered into the conduit 10 by the chemical treatment supply 36, or the substance may not be a chemical treatment. In some examples, the substance 18 may be selected based on its different acoustic property (or properties) as compared to the ambient fluid 20 in the conduit 10. Delivery of the substance 18 into the conduit 10 may be manually controlled, controlled by the optical DAS system computer 30, controlled by a computer of the chemical treatment supply 36, or otherwise controlled.

In step 54, displacement of the substance 18 along the conduit 10 is tracked by the optical DAS system 16. In the FIG. 2 example, the optical waveguide 22 can detect an acoustic anomaly (a change in an acoustic parameter, such as, amplitude, frequency, etc.) due to the presence of the substance 18 as it traverses the conduit 10.

In step 56, a velocity profile is determined for the displacement of the substance 18 through the conduit 10. An example velocity profile (velocity versus distance) is depicted in FIG. 3B.

In step 58, a flow area profile is determined for the conduit 10, based on the velocity profile determined in step 56. An example flow area profile (flow area versus distance) is depicted in FIG. 3C.

In step 60, the deposit build-up 12 location and volume are determined, based on the flow area profile determined in step 58. An example thickness profile (thickness versus distance), which indicates locations of the deposit build-up 12, is depicted in FIG. 3D. A volume of the deposit build-up 12 can be determined by integrating the thickness profile.

In optional step 62, a chemical treatment is introduced into the conduit 10, such as, using the chemical treatment supply 36. Knowing the location(s) and volume(s) of the deposit build-up 12 can aid in selecting appropriate parameters of the chemical treatment (such as, frequency, location, duration, concentration, volume, quantity, etc.) to mitigate the deposit build-up.

After the chemical treatment has been delivered into the conduit 10, an effectiveness of the chemical treatment may be evaluated by repeating steps 52-60. In some examples, the substance 18 introduced into the conduit 10 in step 52 can comprise the chemical treatment, in which case the separate step 62 may not be used.

In optional step 64, the chemical treatment process can be optimized. For example, as mentioned above, the effectiveness of the chemical treatment can be evaluated by repeating steps 52-60, and the delivery of the chemical treatment into the conduit 10 can be varied (e.g., by appropriately adjusting certain parameters, such as, frequency, location, duration, concentration, volume, quantity, etc.), based on this information.

The optimization step 64 can be performed to minimize an expense of the chemical treatment process while maintaining an acceptable flow area through the conduit 10, to maximize an effectiveness or efficiency of the chemical treatment process, to maximize an expected useful life of the conduit, to maximize net present value, or to accomplish any other desirable objective(s).

The delivery of the chemical treatment into the conduit 10 can be automated, for example, using the computer 30 of the optical DAS system 16, a computer of the chemical treatment supply 36, or another computer. For example, delivery of the chemical treatment into the conduit 1U can be automatically performed in response to detection of a predetermined threshold level of deposit build-up 12 thickness or volume. As another example, delivery of the chemical treatment into the conduit 10 can be automatically performed to carry out the optimization performed in step 64 of the method 50.

Although the method 50 is depicted in FIG. 4 as including certain separate steps, it will be readily appreciated that these steps could in other examples be combined or otherwise not be separately performed. For example, the thickness of the deposit build-up 12 along the conduit 10 can be determined (based on the detected displacement of the substance 18 through the conduit and known parameters, such as, the flow rate and the conduit inner diameter), without separately determining the substance velocity profile (step 56) and the flow area profile (step 58). Thus, the scope of this disclosure is not limited to performing any particular steps in any particular order in the method 50.

It may now be fully appreciated that the above disclosure provides significant advances to the arts of monitoring, preventing and mitigating the build-up of deposits in conduits. In examples described above, a thickness of the deposit build-up 12 at any location along the conduit 10 can be readily determined by flowing the substance 18 through the conduit and tracking the substance's displacement along the conduit with the optical DAS system 16.

In particular, a conduit monitoring system 14 is provided to the art by the above disclosure. In one example, the system 14 can include a chemical treatment supply 36, and an optical distributed acoustic sensing system 16. The chemical treatment supply 36 delivers a chemical treatment into a conduit 10 automatically in response to detection by the optical distributed acoustic sensing system 16 of a deposit build-up 12 in the conduit 10.

The optical distributed acoustic sensing system 16 can detect the deposit build-up 12 by tracking displacement of a substance 18 through the conduit 10. Determination of various parameters (such as, conduit 10 flow area, deposit build-up 12 thickness and volume, etc.) may be performed by the optical distributed acoustic sensing system 16, or by other equipment/instruments.

A location, a frequency, a quantity, a duration and/or a concentration of the chemical treatment delivery by the chemical treatment supply 36 may automatically vary in response to a change in the deposit build-up 12 detected by the optical distributed acoustic sensing system 16.

The chemical treatment supply 36 may be connected to a computer 30 of the optical distributed acoustic sensing system 16.

The optical distributed acoustic sensing system 16 can include an optical waveguide 22 which extends along the conduit 10.

A flow area profile (see FIG. 3C) along the conduit 10 may be determined by the chemical treatment supply 36 and/or the optical distributed acoustic sensing system 16.

A deposit thickness profile (see FIG. 3D) along the conduit 10 may be determined by the chemical treatment supply 36 and/or the optical distributed acoustic sensing system 16.

A velocity profile (see FIG. 3B) of a substance 18 along the conduit 10 may be determined by the chemical treatment supply 36 and/or the optical distributed acoustic sensing system 16.

The substance 18 can have a property different from that of ambient fluid 20 in the conduit 10. The property may comprise an acoustic velocity and/or density.

A method 50 of mitigating deposit build-up 12 in a conduit 10 is also provided to the art by the above disclosure. In one example, the method can comprise: detecting a substance 18 as the substance flows through the conduit 10, the detecting step being performed by an optical distributed acoustic sensing system 16; and determining a location and volume of the deposit build-up 12 along the conduit 10, based on the detecting step.

The determining step can comprise determining a velocity profile (see FIG. 3B) of the substance 18 along the conduit 10, and/or determining a flow area profile (see FIG. 3C) along the conduit 10.

The detecting step can comprise detecting an acoustic anomaly along the conduit 10, the acoustic anomaly being caused by the substance 18 having an acoustic property different from that of ambient fluid 20 in the conduit 10.

The method may also include automatically varying at least one of a chemical treatment location, frequency, quantity, duration and concentration, based on the determining step.

The substance 18 may comprise a chemical treatment which mitigates the deposit build-up 12.

Another method 50 of mitigating deposit build-up 12 in a conduit 10 can comprise: detecting a substance 18 as the substance flows through the conduit 1U, the detecting step being performed by an optical distributed acoustic sensing system 16; determining a location and volume of the deposit build-up 12 along the conduit 10, based on the detecting step; and automatically controlling a chemical treatment supply 36, based on the determining step, thereby optimizing mitigation of the deposit build-up 12.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

In the above description of the representative examples, directional terms (such as “above,” “below,” “upper,” “lower,” etc.) are used for convenience in referring to the accompanying drawings. However, it should be clearly understood that the scope of this disclosure is not limited to any particular directions described herein.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A method of mitigating deposit build-up in a conduit, the method comprising:
detecting a substance as the substance flows through the conduit, the detecting being performed by an optical distributed acoustic sensing system; and
determining a location and volume of the deposit build-up along the conduit, based on the detecting.

2. The method of claim 1, wherein the determining further comprises determining a velocity profile of the substance along the conduit.

3. The method of claim 1, wherein the determining further comprises determining a flow area profile along the conduit.

4. The method of claim 1, wherein the detecting further comprises detecting an acoustic anomaly along the conduit, the acoustic anomaly being caused by the substance having an acoustic property different from that of ambient fluid in the conduit.

5. The method of claim 1, further comprising automatically varying at least one of a chemical treatment location, frequency, quantity, duration and concentration, based on the determining.

6. The method of claim 1, wherein the substance comprises a chemical treatment which mitigates the deposit build-up.

7. A conduit monitoring system, comprising:
a chemical treatment supply; and
an optical distributed acoustic sensing system,
wherein the chemical treatment supply delivers a chemical treatment into a conduit automatically in response to detection by the optical distributed acoustic sensing system of a deposit build-up in the conduit.

8. The conduit monitoring system of claim 7, wherein at least one of a location, a frequency, a quantity, a duration and a concentration of the chemical treatment delivery by the chemical treatment supply automatically varies in response to a change in the deposit build-up detected by the optical distributed acoustic sensing system.

9. The conduit monitoring system of claim 7, wherein the chemical treatment supply is connected to a computer of the optical distributed acoustic sensing system.

10. The conduit monitoring system of claim 7, wherein the optical distributed acoustic sensing system includes an optical waveguide which extends along the conduit.

11. The conduit monitoring system of claim 7, wherein a flow area profile along the conduit is determined by at least one of the chemical treatment supply and the optical distributed acoustic sensing system.

12. The conduit monitoring system of claim 7, wherein a deposit thickness profile along the conduit is determined by at least one of the chemical treatment supply and the optical distributed acoustic sensing system.

13. The conduit monitoring system of claim 7, wherein a velocity profile of a substance along the conduit is determined by at least one of the chemical treatment supply and the optical distributed acoustic sensing system.

14. The conduit monitoring system of claim 13, wherein the substance has a property different from that of ambient fluid in the conduit, the property comprising at least one of acoustic velocity and density.

15. A method of mitigating deposit build-up in a conduit, the method comprising:
detecting a substance as the substance flows through the conduit, the detecting being performed by an optical distributed acoustic sensing system;
determining a location and volume of the deposit build-up along the conduit, based on the detecting; and
automatically controlling a chemical treatment supply, based on the determining, thereby optimizing mitigation of the deposit build-up.

16. The method of claim 15, wherein the controlling further comprises automatically varying at least one of a chemical treatment location, frequency, quantity, duration and concentration, based on the determining.

17. The method of claim 15, wherein the determining further comprises determining a velocity profile of the substance along the conduit.

18. The method of claim 15, wherein the determining further comprises determining a flow area profile along the conduit.

19. The method of claim 15, wherein the detecting further comprises detecting an acoustic anomaly along the conduit, the acoustic anomaly being caused by the substance having an acoustic property different from ambient fluid in the conduit.

20. The method of claim 15, wherein the substance comprises a chemical treatment which mitigates the deposit build-up.
